(19) United States
(12) Patent Application Publication
(10) Pub. No.: US 2009/0009107 A1
(43) Pub. Date: Jan. 8, 2009

(54) LIGHT-EMITTING DEVICE, ELECTRONIC DEVICE, AND DRIVING METHOD OF LIGHT-EMITTING DEVICE

(75) Inventors: Ryoji NOMURA, Yamato (JP); Nobuharu OHSAWA, Zama (JP); Satoshi SEO, Kawasaki (JP); Kaoru KATO, Atsugi (JP)

Correspondence Address: NIXON PEABODY, LLP, 401 9TH STREET, NW, SUITE 900, WASHINGTON, DC, 20004-2128, US

(73) Assignee: SEMICONDUCTOR ENERGY LABORATORY CO., LTD., Atsugi-shi (JP)

(21) Appl. No.: 12/144,283

(22) Filed: Jun. 23, 2008

(30) Foreign Application Priority Data
Jul. 6, 2007 (JP) 2007-178727

(51) Int. Cl. H05B 41/36

(52) U.S. Cl. 315/307

(57) ABSTRACT

An object is to provide a novel driving method of a light-emitting element, particularly, an organic EL element. Another object is to provide a light-emitting device having a light-emitting element for which the driving method is employed and an electronic device having the light-emitting device as a display portion. A light-emitting device is provided, which includes: a pixel portion having a light-emitting element; a control switch connected to the pixel portion; and a sensor portion connected to the control switch. The control switch includes a unit configured to determine whether the light-emitting element emits light depending on an ambient temperature that is sensed by the sensor portion.

### BACKGROUND OF THE INVENTION

1. Field of the Invention

The present invention relates to a light-emitting device and an electronic device each having a light-emitting element which utilizes electroluminescence. The present invention also relates to a driving method of a light-emitting device.

2. Description of the Related Art

In recent years, the development of EL elements, in which films containing a compound that exhibits electroluminescence (EL) are used as light-emitting layers, has advanced, and EL elements using various compounds have been proposed. In addition, flat panel displays and lighting devices, in which such EL elements are used as light-emitting elements, have been developed.

It is known that light-emitting devices using EL elements include an active-matrix type and a passive-matrix type. The passive-matrix type is a light-emitting device using an EL element having a structure in which an EL film is interposed between anodes and cathodes that are provided in stripes perpendicular to each other. The active-matrix type is that in which a thin film transistor (hereinafter referred to as a TFT) is provided in each pixel and a current flowing to an EL element is controlled using the TFT that is connected to an anode or a cathode of the EL element.

Either light-emitting device can provide light emission through current flow to an EL element; however, a gradual decrease in luminance (that is, deterioration) on driving has been a large problem for an EL element, particularly, an EL element using an organic compound (hereinafter referred to as an organic EL element). With the development of organic materials used for an organic EL element, the lifetime of an organic EL element has been drastically improved whereas complete prevention of deterioration associated with driving has not been accomplished yet.

In particular, the deterioration of an organic EL element is accelerated by driving at high temperature. Specifically, an organic EL element is deteriorated more rapidly when driven at high temperature, for example, at 60° C. or 80° C. than when driven at room temperature.

Light-emitting devices having organic EL elements are mainly applied to small-size displays. For example, they are applied to display portions of cellular phones, personal digital assistants, portable audio devices, and navigation systems, and the like. Cellular phones, personal digital assistants, portable audio devices, and the like are usually used while being carried around by users; thus, it is rare that these devices are driven at high temperatures which are harsh to users. However, for example, when such an electronic device is unintentionally driven while being left in a place exposed to a high temperature, an organic EL element included in a light-emitting device is deteriorated rapidly. For example, in the case where a light-emitting device is used as a display portion of a navigation system, when a closed automobile is exposed to direct sunlight or the like, the temperature of the display portion becomes very high. In particular, when the navigation system is driven in a condition where the temperature inside the automobile is high (for example, 60° C. to 85° C. or so) and before the automobile is put in a condition where a user can stay comfortably, the lifetime of an organic EL element included in the light-emitting device thereof is significantly shortened.

Against such problems, a method has been developed, by which the luminance of an organic EL element is lowered in a high-temperature environment to a necessary extent. For example, Reference 1 discloses that the value of a current to be supplied to an organic EL element is controlled by a current control portion in response to an increase in temperature around a light-emitting device. Similar technical ideas, that is, methods by which luminance, or voltage or current value, is controlled depending on external temperature are disclosed in References 2 to 7.

[Reference 1] Japanese Published Patent Application No. 2001-326073

[Reference 2] Japanese Published Patent Application No. 2004-205704

[Reference 3] Japanese Published Patent Application No. 2005-31430

[Reference 4] Japanese Published Patent Application No. 2005-347141

[Reference 5] Japanese Published Patent Application No. 2003-272835

[Reference 6] Japanese Published Patent Application No. 2005-208510

[Reference 7] Japanese Published Patent Application No. 2005-321789

On the other hand, as other methods, methods for actively lowering the temperature of a light-emitting device not by controlling the luminance of a light-emitting device that is exposed to a high temperature but by providing some kind of temperature adjusting means have been proposed as disclosed in References 8 to 14.

[Reference 8] Japanese Published Patent Application No. 2003-295776

[Reference 9] Japanese Published Patent Application No. 2005-10577

[Reference 10] Japanese Published Patent Application No. 2004-37862

[Reference 11] Japanese Published Patent Application No. 2004-95458

[Reference 12] Japanese Published Patent Application No. 2004-195963

[Reference 13] Japanese Published Patent Application No. 2004-317682

[Reference 14] Japanese Published Patent Application No. 2005-55909

However, by any of these methods, an organic EL element is driven, meaning that an organic EL element emits light even at a high temperature after all, and although deterioration rate can be decreased by luminance control, these methods each have a significant problem in that deterioration itself cannot be suppressed.

### SUMMARY OF THE INVENTION

It is an object of the present invention to solve the foregoing problems. In other words, it is an object to provide a novel driving method of a light-emitting element, particularly, an organic EL element. In addition, it is another object to provide a light-emitting device having a light-emitting element for which the driving method is employed and an electronic device having the light-emitting device as a display portion.

A light-emitting device using an organic EL element is mainly incorporated in a small-sized electronic device. In view of this situation, a light-emitting device using an organic EL element is used in an environment where a user, i.e., a human, can conduct activities comfortably to some extent and is not usually used in a harsh environment that can reach, for example, 60° C. or higher. That is, in an environment where a human cannot conduct activities comfortably to some extent, a light-emitting device using an organic EL element is very unlikely to be driven.

In other words, it can be considered that the foregoing problems can be solved not by lowering of the luminance of an organic EL element but by prevention of light emission of an organic EL element itself in a high-temperature environment which is harsh to a user.

That is, one aspect of the present invention is a light-emitting device including: a pixel portion having a light-emitting element; a control switch connected to the pixel portion; and a sensor portion connected to the control switch. The control switch includes a unit configured to determine whether the light-emitting element emits light depending on an ambient temperature that is sensed by the sensor portion.

A temperature, which is defined in order to determine whether the light-emitting element emits light, may be defined in consideration of a structure of the light-emitting element included in the light-emitting device, a material used for the light-emitting element, or a main environment where an electronic device incorporating the light-emitting device as a pixel portion is used. A specific example of the temperature is about 40° C. to 100° C. In consideration of an environment where a portable electronic device is used, the ambient temperature is preferably 60° C., 80° C., 85° C., etc. Note that the light-emitting device here may be not only one having an organic EL element but also one having an inorganic EL element in which an inorganic compound is used as a light-emitting material.

Another aspect of the present invention is a light-emitting device including, over a single insulator: a pixel portion having a light-emitting element; a control switch connected to the pixel portion; and a sensor portion connected to the control switch. The control switch includes a unit configured to determine whether the light-emitting element emits light depending on an ambient temperature that is sensed by the sensor portion. That is, a feature is also that a circuit including the sensor portion and the control switch is formed over a single insulator in the same step as a step of forming a transistor (including a thin film transistor and a MOS transistor using bulk silicon) to be provided in the pixel portion.

Still another aspect of the present invention is a light-emitting device including: a pixel portion having a light-emitting element; a driver circuit connected to the pixel portion; a control switch connected to the driver circuit; and a sensor portion connected to the control switch. The control switch includes a unit configured to determine whether the light-emitting element emits light depending on an ambient temperature that is sensed by the sensor portion. The pixel portion, the driver circuit, the control switch, and the sensor portion may be formed over a single insulator.

Yet another aspect of the present invention is a driving method of a light-emitting device including a pixel portion having a light-emitting element, a control switch connected to the pixel portion, and a sensor portion connected to the control switch. The control switch determines whether the light-emitting element emits light depending on an ambient temperature that is sensed by the sensor portion. In addition to these components, one that includes a driver circuit connected to the pixel portion is also an aspect of the present invention. The pixel portion, the control switch, the driver circuit, and the sensor portion may be formed over a single insulator.

In addition, the present invention includes, in its scope, an electronic device using the light-emitting device of the present invention in a display portion. Thus, another aspect of the present invention is an electronic device including the aforementioned light-emitting device as a pixel portion.

Note that the light-emitting device in this specification includes image display devices, light-emitting devices, and light sources (including lighting devices). In addition, the light-emitting device includes all of the following modules: a module in which a panel is provided with a connector, for example, a flexible printed circuit (FPC), a tape automated bonding (TAB) tape, or a tape carrier package (TCP); a module provided with a printed wiring board at the end of a TAB tape or a TCP; and a module where an integrated circuit (IC) is directly mounted by a chip-on-glass (COG) method on a substrate where a light-emitting element is formed.

The present invention discloses a light-emitting device, in which a sensor portion provided in the light-emitting device senses an ambient temperature and controls a control switch depending on a given predefined temperature, and the control switch includes a unit configured to determine whether a light-emitting element emits light, and also discloses an electronic device having the light-emitting device as a display portion. This defined temperature may be determined in consideration of the maximum value of an ambient temperature at which a user, i.e., a human, can comfortably use the electronic device. That is, the present invention provides a control unit configured to prevent a light-emitting device from being driven in a harsh environment where a user, i.e., a human, does not usually use an electronic device. This makes it possible to prevent a light-emitting device from being driven unnecessarily or unintentionally and to drastically improve the lifetime of a light-emitting device and an electronic device having the light-emitting device.

### BRIEF DESCRIPTION OF THE DRAWINGS

FIG. 1 is a block diagram of a light-emitting device.

FIG. 2 is a configuration diagram of a light-emitting device.

FIG. 3 is a diagram showing a temperature detection portion, a temperature detection portion circuit, and a control switch.

FIG. 4 is a circuit configuration diagram of a pixel.

FIGS. 5A to 5E are diagrams each showing an electronic device.

FIGS. 6A and 6B are diagrams each showing a light-emitting element.

FIG. 7 is a diagram showing a light-emitting element.

FIGS. 8A and 8B are diagrams showing a light-emitting device.

FIGS. 9A and 9B are diagrams showing a light-emitting device.

FIGS. 10A to 10C are diagrams each showing an electronic device.

### DETAILED DESCRIPTION OF THE INVENTION

Embodiment modes of the present invention will be hereinafter described with reference to the accompanying drawings. However, the present invention is not limited to the following description. It is easily understood by those skilled in the art that the mode and detail of the present invention can be changed in various ways without departing from the spirit and scope thereof. Thus, the present invention is not interpreted as being limited to the following description of the embodiment modes.

### Embodiment Mode 1

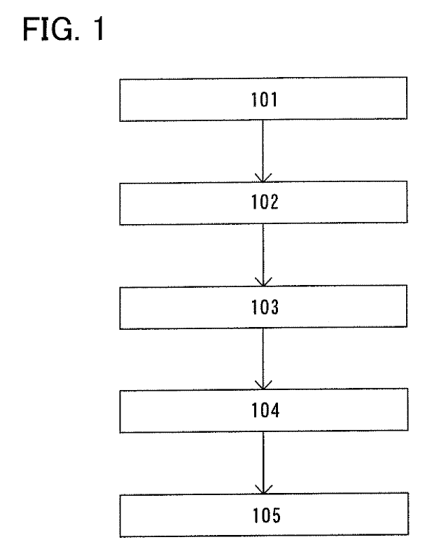

A circuit structure of a light-emitting device of the present invention is described. FIG. 1 is a circuit block diagram of a light-emitting device of the present invention. In FIG. 1, reference numeral 101 denotes a temperature detection portion, which detects an ambient temperature around the light-emitting device. An ambient temperature is detected with the temperature detection portion which is provided at a given position within the light-emitting device. The temperature detection portion may be formed over the same substrate as a temperature detection portion circuit 102, a control switch 103, a driver circuit 104, and a display portion 105 or may be formed over a different substrate. The temperature detection portion circuit 102 detects a change in current or voltage generated in the temperature detection portion 101 and outputs a signal to the control switch 103 after analog-to-digital conversion (AD conversion). The temperature detection portion circuit 102 transmits a signal to the control switch 103 so that the driver circuit is turned on when the ambient temperature detected is lower than a predetermined temperature. Then, the control switch 103 turns the driver circuit 104 on, which allows the driver circuit 104 to supply a current or a signal to the display portion 105 and allows a predetermined light-emitting element in the display portion 105 to emit light.

On the other hand, when the ambient temperature detected by the temperature detection portion is equal to or higher than the predetermined temperature, the supply of the signal to the driver circuit 104 is stopped to stop the supply of power or a signal so that the display portion 105 does not emit light. The predetermined temperature can be selected optionally, considering an environment where an electronic device installed with the light-emitting device is mainly used. Specifically, the predetermined temperature may be set to be about 40° C. to 80° C. The temperature detection portion is formed using a semiconductor element or the like, such as a thermistor with resistance varying according to its temperature or a diode with voltage of a PIN junction portion varying according to temperature change. The temperature detection portion is not limited to such a structure and may be formed using various kinds of sensor technology. The temperature detection portion circuit 102 detects a change in current generated in the temperature detection portion, outputs a signal to the control switch 103 after analog-to-digital conversion (AD conversion), and is formed using an analog buffer or the like. Various types of switches can be used as the control switch, examples of which include electrical switches, mechanical switches, and the like. That is, any switch that can control the flow of a current is acceptable, and there is no particular limitation. For example, a transistor, a diode (such as a PN diode, a PIN diode, a Schottky diode, or a diode-connected transistor), or a logic circuit which is a combination of such elements may be used.

Such a control method allows the control switch 103 to cut off current supply to the display portion 105, when the display portion 105 is exposed to high temperature, and prohibits the operation of a light-emitting element in the display portion 105 at high temperature. Accordingly, the lifetime of the light-emitting element can be extended.

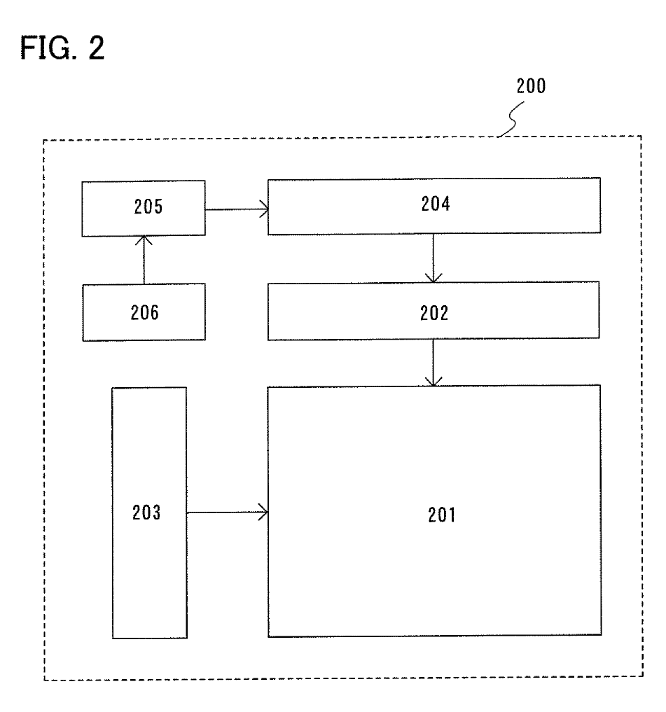

FIG. 2 shows a structure of a light-emitting device. A light-emitting device 200 shown in FIG. 2 has a pixel portion 201, a data signal side driver circuit 202, a gate signal side driver circuit 203, a control switch 204, a temperature detection portion circuit 205, and a temperature detection portion 206. The control switch 204 controls whether or not a signal is supplied from a data signal line (not shown) to the data signal side driver circuit 202 based on a signal which is transmitted from the temperature detection portion 206 through the temperature detection portion circuit 205. Accordingly, it can be determined whether or not to supply a current to the pixel portion 201. The temperature detection portion 206 detects an ambient temperature around the light-emitting device with a thermistor or the like. Note that, although FIG. 2 demonstrates the ON-OFF of the data signal side driver circuit, whether the gate signal side driver circuit is turned on or off may alternatively be controlled.

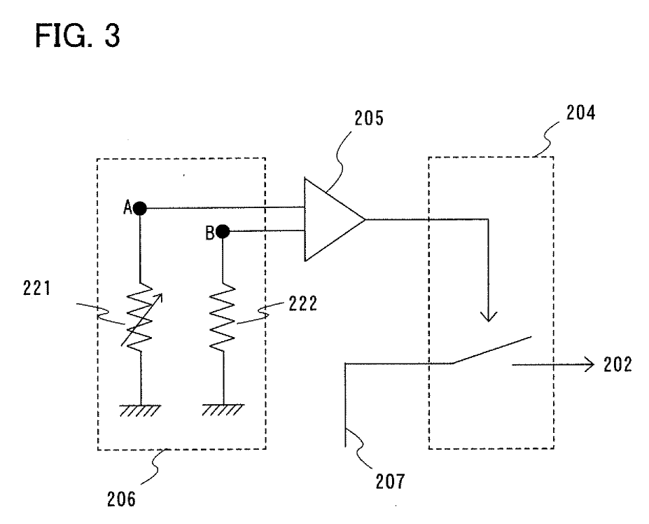

FIG. 3 shows a structure with the temperature detection portion 206, the temperature detection portion circuit 205, and the control switch 204. The temperature detection portion 206 shown in FIG. 3 detects an ambient temperature with the use of a thermistor; however, any of various temperature detection means, such as a sensor using another semiconductor element like a diode, may be employed optionally. Depending on whether a voltage at B determined by a resistor 222 of the temperature detection portion 206 is higher or lower than a voltage at A determined by a thermistor 221, an output from an analog buffer included in the temperature detection portion circuit 205 is determined. Based on an output voltage from this analog buffer, whether the control switch 204 is turned on or off is controlled. The data signal side driver circuit 202 is controlled by an external data signal, and in this embodiment mode, whether or not a signal is supplied from a data signal line 207 is controlled by the control switch 204. Note that, as described above, the control switch 204 may control whether or not a gate signal is supplied or may control whether or not a current is supplied to a light-emitting element.

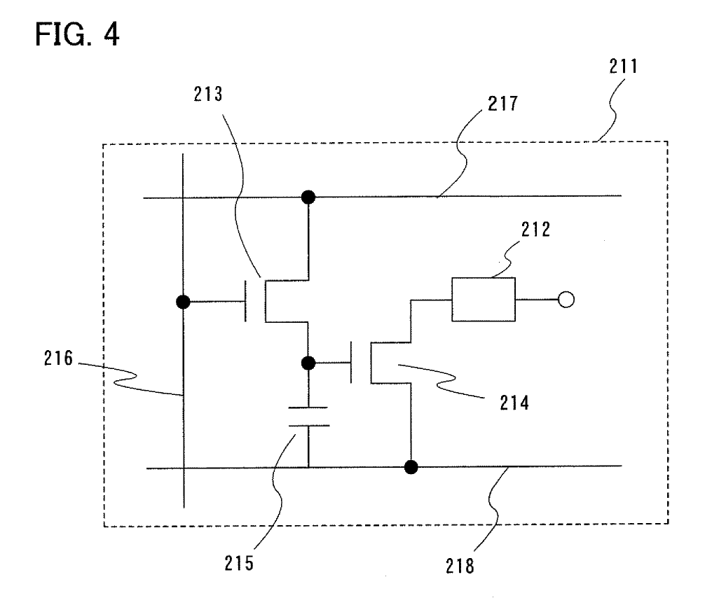

The structure described in this embodiment mode can be employed for either a passive-matrix light-emitting device or an active-matrix light-emitting device. As an example, FIG. 4 shows an active-matrix light-emitting device in which a TFT is provided in each pixel.

FIG. 4 shows an example of a circuit structure of a pixel 211. Here, the pixel 211 has a light-emitting element 212, a switching TFT 213, a current control TFT 214, and a capacitor 215.

The switching TFT 213 is a TFT for controlling a gate of the current control TFT 214; a gate thereof is electrically connected to a gate line 216; and the switching TFT 213 transmits a signal that is transmitted through a data line 217 to the gate of the current control TFT 214. The current control TFT 214 is a TFT for controlling a current that flows to the light-emitting element 212, and supplies a current that is transmitted through a current supply line 218 to the light-emitting element 212.

The gate electrode of the switching TFT 213 is electrically connected to the gate line 216, and a first electrode thereof is electrically connected to the data line 217. A second electrode thereof is electrically connected to the gate electrode of the current control TFT 214. A first electrode of the current control TFT 214 is connected to the current supply line 218, and a second electrode thereof is electrically connected to an electrode of the light-emitting element 212. Between the second electrode of the switching TFT 213 and the current supply line 218, the capacitor 215 is provided, which holds the potential of the gate electrode of the current control TFT 214.

Although the circuit structure where one pixel is provided with two transistors, one capacitor, and one light-emitting element is described in this embodiment mode, the present invention is not limited to such a structure. In one pixel, two or more transistors may be disposed, and there may be a plurality of light-emitting elements. Furthermore, a plurality of light-emitting elements may be connected in series, or a so-called stacked light-emitting element in which a plurality of light-emitting elements is stacked may be provided.

When the gate line 216 is selected, the switching TFT 213 is in an on state. The on state refers to a state in which the absolute value of a gate-source voltage of a TFT is higher than the absolute value of a threshold value thereof and current flows between a source and a drain. On the other hand, an off state refers to a state in which the absolute value of a gate-source voltage of a TFT is lower than the absolute value of a threshold value thereof and current does not flow between a source and a drain (excluding a slight amount of leakage current). When the switching TFT 213 is in the on state, a video signal is input to the gate electrode of the current control TFT 214 from the data line 217 through the switching TFT 213. Accordingly, the current control TFT 214 is in the on state; current flows to the light-emitting element 212 from the current supply line 218 through the current control TFT 214; and the light-emitting element 212 is made to emit light.

In the present invention, when ambient temperature becomes equal to or higher than a predetermined temperature, a control switch stops each pixel, which is included in a light-emitting portion, emitting light. Specifically, power supply to the gate line 216 is stopped; accordingly, power supply to the gate of the switching TFT 213 is stopped. Therefore, all switching TFTs are put in the off state, and as a result, all pixels are stopped emitting light. Alternatively, power supply to the data line may be controlled by the control switch. Similarly, power supply to the current supply line 218 may be stopped by the control switch. Even when any of the methods is selected, each pixel can be stopped emitting light; accordingly, a pixel portion can be prevented from emitting light at a harsh ambient temperature where practical use is unlikely. Accordingly, the lifetime of a light-emitting element can be extended.

As described above, the circuit structure shown in FIG. 4 is a mere example, and any of various circuit structures may be used as long as light emission of a light-emitting element can be controlled.

### Embodiment Mode 2

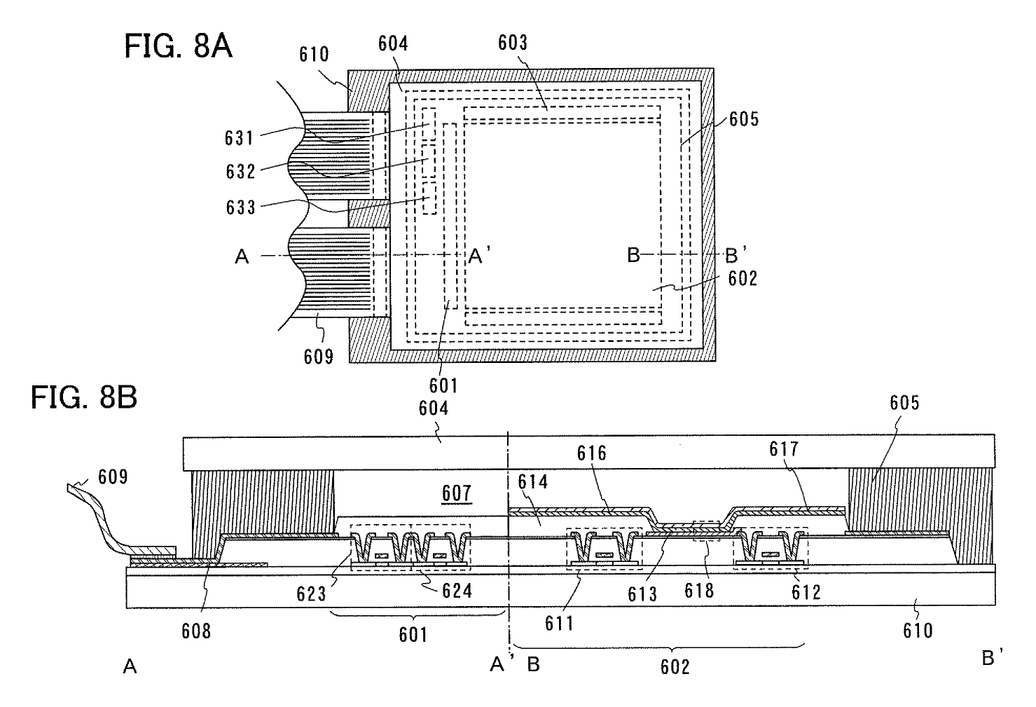

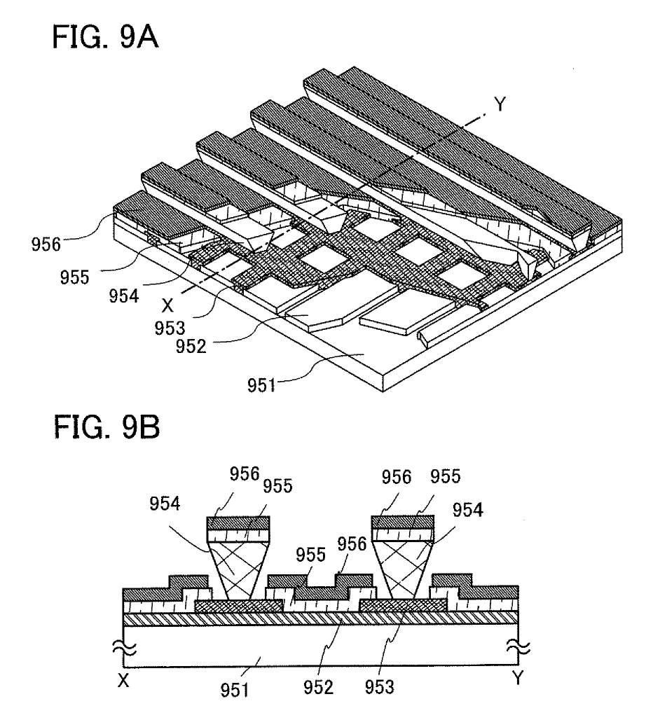

In this embodiment mode, structures of light-emitting devices of the present invention are described with reference to FIGS. 8A to 8C and FIGS. 9A and 9B.

FIGS. 8A and 8B show an active-matrix light-emitting device in which a thin film transistor (TFT) is provided in each pixel to control driving of a light-emitting element. Note that FIG. 8A is a top view showing the light-emitting device, and FIG. 8B is a cross-sectional view of FIG. 8A taken along lines A-A′ and B-B′. This light-emitting device includes a driver circuit portion (a source side driver circuit) 601, a pixel portion 602, and a driver circuit portion (a gate side driver circuit) 603, which are indicated by dashed lines, in order to control light emission of a light-emitting element. Reference numeral 604 denotes a sealing substrate; 605, a sealant; and 607, a space surrounded by the sealant 605. The light-emitting device also includes a temperature detection portion 631, a temperature detection portion circuit 632, and a control switch 633.

Note that a lead wiring 608 is a wiring for transmitting signals to be input to the source side driver circuit 601 and the gate side driver circuit 603 and receives a video signal, a clock signal, a start signal, a reset signal, and the like from a flexible printed circuit (FPC) 609 that serves as an external input terminal. Note that only the FPC is shown here; however, the FPC may be provided with a printed wiring board (PWB). The light-emitting device in this specification includes not only a main body of a light-emitting device but also a light-emitting device with an FPC or a PWB attached.

Next, a cross-sectional structure is described with reference to FIG. 8B. The driver circuit portion and the pixel portion are formed over an element substrate 610. Here, the source side driver circuit 601 that is the driver circuit portion and one pixel in the pixel portion 602 are shown.

Note that the source side driver circuit 601 is formed using a CMOS circuit that is a combination of an n-channel TFT 623 and a p-channel TFT 624. The driver circuit may be formed using any kind of CMOS circuits, PMOS circuits, or NMOS circuits. In this embodiment mode, a driver-integration type in which a driver circuit is formed over a substrate is described, but it is not necessarily required and a driver circuit can be formed not over a substrate but outside a substrate.

The pixel portion 602 has a plurality of pixels, each of which includes a switching TFT 611, a current control TFT 612, and a first electrode 613 which is electrically connected to a drain of the current control TFT 612. Note that an insulator 614 is formed to cover an end portion of the first electrode 613. Here, the insulator 614 is formed using a positive type photosensitive acrylic resin film.

The insulator 614 is formed to have a curved surface with curvature at an upper end portion or a lower end portion thereof in order to obtain favorable coverage. For example, in the case where positive type photosensitive acrylic is used as a material of the insulator 614, it is preferable that the insulator 614 be formed to have a curved surface with a curvature radius (0.2 μm to 3 μm) only at an upper end portion. For the insulator 614, either a negative type which becomes insoluble in an etchant by light irradiation or a positive type which becomes soluble in an etchant by light irradiation can be used.

Over the first electrode 613, an EL layer 616 and a second electrode 617 are formed. Here, as a material of the first electrode 613, any of various kinds of metals, alloys, conductive compounds, and mixtures thereof can be used. In the case where the first electrode is used as an anode, among those materials, a metal, an alloy, a conductive compound, a mixture thereof, or the like having a high work function (a work function of 4.0 eV or higher) is preferably used. For example, a single-layer film such as an indium tin oxide film containing silicon, an indium zinc oxide film, a titanium nitride film, a chromium film, a tungsten film, a Zn film, or a Pt film; a stacked-layer film of a titanium nitride film and a film containing aluminum as its main component; a stacked-layer film having a three-layer structure of a titanium nitride film, a film containing aluminum as its main component, and a titanium nitride film; or the like can be used. When the first electrode 613 has a stacked-layer structure, it has low resistance as a wiring, can form a favorable ohmic contact, and can function as an anode.

The EL layer 616 is formed by any of various methods such as an evaporation method using an evaporation mask, an inkjet method, and a spin coating method. As a material of the EL layer 616, any of a low molecular compound, a high molecular compound, an oligomer, and a dendrimer may be used. Furthermore, as a material of the EL layer, not only an organic compound but also an inorganic compound may be used.

As a material of the second electrode 617, any of various kinds of metals, alloys, conductive compounds, and mixtures thereof can be used. In the case where the second electrode is used as a cathode, among those materials, a metal, an alloy, a conductive compound, a mixture thereof, or the like having a low work function (a work function of 3.8 eV or lower) is preferably used. Examples include: elements belonging to Group 1 and 2 of the periodic table (that is, alkali metals such as lithium (Li) and cesium (Cs), and alkaline earth metals such as magnesium (Mg), calcium (Ca), and strontium (Sr)); alloys containing any of these elements (such as MgAg and AlLi); and the like. Note that, in the case where light generated in the EL layer 616 is transmitted through the second electrode 617, the second electrode 617 may also be formed using a stacked layer of a thin metal film and a transparent conductive film (e.g., indium tin oxide (ITO), indium tin oxide containing silicon or silicon oxide, indium zinc oxide (IZO), or indium oxide containing tungsten oxide and zinc oxide (IWZO)).

Furthermore, by attachment of the sealing substrate 604 to the element substrate 610 with the sealant 605, a structure is obtained in which a light-emitting element 618 is provided in the space 607 surrounded by the element substrate 610, the sealing substrate 604, and the sealant 605. Note that the space 607 is filled with a filler, and there is also a case where the space 607 is filled with the sealant 605 or filled with an inert gas (such as nitrogen or argon).

Note that, as the sealant 605, an epoxy-based resin is preferably used. It is desired that the material allow as little moisture and oxygen as possible to penetrate. As the sealing substrate 604, a plastic substrate formed of fiberglass-reinforced plastics (FRP), polyvinyl fluoride (PVF), polyester, acrylic, or the like can be used besides a glass substrate or a quartz substrate.

As described above, the light-emitting device of the present invention can be obtained. Note that the structures of the TFTs are not limited to those shown in FIGS. 8A and 8B. Either a staggered TFT or an inverted staggered TFT may be employed. In addition, a driver circuit formed over a TFT substrate may be formed using an n-type TFT and a p-type TFT, or using either an n-type TFT or a p-type TFT. Furthermore, there is no particular limitation on the crystallinity of a semiconductor film used for the TFTs. Either an amorphous semiconductor film or a crystalline semiconductor film may be used. Alternatively, a single-crystal semiconductor film may be used. A single-crystal semiconductor film can be manufactured using a Smart Cut (registered trademark) method or the like.

Although the active-matrix light-emitting device in which driving of a light-emitting element is controlled by a transistor is described in this embodiment mode as above, a passive-matrix light-emitting device may also be employed. A passive-matrix light-emitting device is that which uses a light-emitting element having a structure where an EL layer is sandwiched between anodes and cathodes which are provided in stripes perpendicular to each other. FIGS. 9A and 9B show a passive-matrix light-emitting device which is manufactured by application of the present invention. FIG. 9A is a perspective view showing the light-emitting device, and FIG. 9B is a cross-sectional view of FIG. 9A taken along a line X-Y. In FIGS. 9A and 9B, over a substrate 951, an EL layer 955 is provided between electrodes 952 and electrodes 956. End portions of the electrodes 952 are covered with an insulating layer 953. Then, partition layers 954 are provided over the insulating layer 953. Side walls of the partition layers 954 slope so that a distance between one side wall and the other side wall becomes narrower toward the substrate surface. That is, the cross section of the partition layer 954 in the direction of a narrow side is trapezoidal, and the base (a side facing in the same direction as a plane direction of the insulating layer 953 and in contact with the insulating layer 953) is shorter than the upper side (a side facing in the same direction as the plane direction of the insulating layer 953 and not in contact with the insulating layer 953). By provision of the partition layers 954 in this manner, defects of light-emitting elements resulting from crosstalk or the like can be prevented.

In the light-emitting device of the present invention, the temperature detection portion 631 senses ambient temperature, and based on an output signal thereof the control switch 633 determines whether or not a current is supplied to a driver circuit. Accordingly, a pixel portion including a light-emitting element connected to the driver circuit switches between a display mode and a non-display mode. Thus, in a harsh environment where a user does not usually use a display device, specifically, at a high temperature at which a user does not comfortably use a display device, a display portion can be controlled so as not to perform display. Accordingly, the reliability of a light-emitting element can be improved, and the lifetime of a light-emitting portion of a light-emitting device can be extended.

Note that this embodiment mode can be appropriately combined with any of the other embodiment modes.

### Embodiment Mode 3

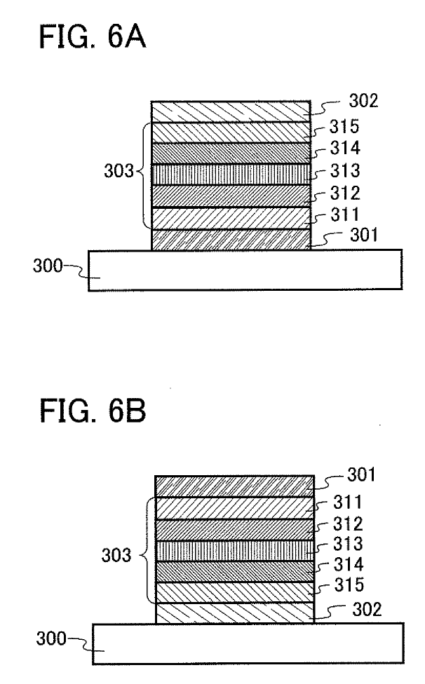

In this embodiment mode, a structure of a light-emitting element for implementing the present invention is described. In this embodiment mode, as the light-emitting element, organic EL elements shown in FIGS. 6A and 6B are described.

In each of FIGS. 6A and 6B, a substrate 300 is used as a support for a light-emitting element. For the substrate 300, glass, quartz, or plastic having plasticity may be used.

The light-emitting element has a first electrode 301, a second electrode 302, and an EL layer 303 which is provided between the first electrode 301 and the second electrode 302. Note that, in this embodiment mode, description is made below on the assumption that the first electrode 301 functions as an anode and the second electrode functions as a cathode.

For the first electrode 301, a metal, an alloy, a conductive compound, a mixture thereof, or the like having a high work function (specifically, preferably 4.0 eV or higher) is preferably used. Specific examples include: indium tin oxide (ITO); indium tin oxide containing silicon or silicon oxide; indium zinc oxide (IZO); indium oxide containing tungsten oxide and zinc oxide (IWZO); and the like. Conductive metal oxide films of them are generally formed by sputtering, but they may be formed by application of a sol-gel method or the like. For example, a film of indium zinc oxide (IZO) can be formed by a sputtering method using a target in which zinc oxide of 1 wt % to 20 wt % is added to indium oxide. A film of indium oxide containing tungsten oxide and zinc oxide (IWZO) can be formed by a sputtering method using a target which contains tungsten oxide of 0.5 wt % to 5 wt % and zinc oxide of 0.1 wt % to 1 wt % in indium oxide. Other examples include: gold (Au); platinum (Pt); nickel (Ni); tungsten (W); chromium (Cr); molybdenum (Mo); iron (Fe); cobalt (Co); copper (Cu); palladium (Pd); nitride of a metal material (such as titanium nitride); and the like.

A stack structure of layers of the EL layer 303 is not particularly limited. The EL layer 303 may be formed by an appropriate combination of a material which exhibits a high electron transporting property, a material which exhibits a high hole transporting property, a bipolar material which exhibits a high electron transporting property and a high hole transporting property, a material which exhibits an electron injecting property, and a material which exhibits a hole injecting property. For example, the EL layer 303 can be formed by an appropriate combination of a hole injecting layer, a hole transporting layer, a light-emitting layer, an electron transporting layer, an electron injecting layer, and the like.

A hole injecting layer 311 is a layer which is formed of a material which exhibits a high hole injecting property. For example, a layer containing a composite material containing an organic compound which exhibits a high hole transporting property and an inorganic compound which exhibits an electron accepting property can be used. Note that, in this specification, “composite” refers to not only a state in which two materials are simply mixed but also a state in which a plurality of materials is mixed so that charges can be transferred between the materials.

One example of an inorganic compound, which is used for a composite material and exhibits an electron accepting property, is a transition metal oxide. Another example is an oxide of a metal belonging to any of Groups 4 to 8 of the periodic table. Specifically, vanadium oxide, niobium oxide, tantalum oxide, chromium oxide, molybdenum oxide, tungsten oxide, manganese oxide, and rhenium oxide are preferable because of their high electron accepting properties. Among these, molybdenum oxide is especially preferable because it is stable in the atmosphere, its hygroscopic property is low, and it can be easily handled.

As an organic compound, which is used for a composite material and exhibits a high hole transporting property, any of various compounds such as an aromatic amine compound, a carbazole derivative, an aromatic hydrocarbon, a high molecular compound, an oligomer, a dendrimer, and the like can be used. Note that it is preferable that an organic compound used for a composite material be a material which has a hole mobility of 10⁻⁶ cm²/Vs or higher. Note that any other material that exhibits a hole transporting property which is higher than an electron transporting property may be used. Examples of an organic compound which can be used for a composite material include: an aromatic amine compound; a carbazole derivative; a condensed aromatic compound; a stilbene derivative; a polymer, an oligomer, and a dendrimer containing an amino group or a carbazolyl group; and the like.

A hole transporting layer 312 is formed of a material which exhibits a hole transporting property. As a hole transporting material, an aromatic amine compound; a polymer, an oligomer, or a dendrimer containing an amino group or a carbazolyl group; or the like can be used. A single layer of such a hole transporting material may be formed, or a stacked layer of a plurality of materials may be formed.

A light-emitting layer 313 is a layer containing a material which exhibits a high light-emitting property. As a material which exhibits a high light-emitting property, a fluorescent compound which exhibits fluorescence or a phosphorescent compound which exhibits phosphorescence can be used.

As a phosphorescent compound which can be used for the light-emitting layer, a transition metal compound which contains, for example, iridium, ruthenium, platinum, or a rare earth metal as its central metal can be used. Examples of a fluorescent compound which can be used for the light-emitting layer include: a stilbene derivative; an anthracene derivative; a quinacridon derivative; a coumarin derivative; a tetracene derivative; a fluoranthene derivative; a pyrene derivative; and the like. Any of these light-emitting materials can be used alone, but may be used while being added to another carrier transporting material.

An electron transporting layer 314 is formed of an electron transporting material, and for example, a metal complex having a quinoline skeleton or a benzoquinoline skeleton, which contains Al, Li, or Be as its central metal, can be used. Alternatively, a metal complex having an oxazole-based ligand or a thiazole-based ligand, which contains a typical metal such as zinc as its central metal, can be used. Still alternatively, besides a metal complex, a phenanthroline derivative, an oxadiazole derivative, an oligopyridine derivative, or the like can be used. The electron transporting layer may be formed using not only a single layer but also a stacked layer of two or more layers of the above-mentioned materials.

Over the electron transporting layer 314, an electron injecting layer 315 may be provided. For the electron injecting layer 315, an alkali metal compound or an alkaline earth metal compound can be used. Alternatively, a layer of a material which exhibits an electron transporting property and is doped with an alkali metal or an alkaline earth metal may be used.

As a material used to form the second electrode 302, a metal, an alloy, a conductive compound, a mixture thereof, or the like having a low work function (specifically, preferably 3.8 eV or lower) can be used. Specific examples of such a cathode material include: an alkali metal, an alkaline earth metal, and an alloy thereof; a rare earth metal, and an alloy thereof; and the like. In addition, by provision of the electron injecting layer 315 between the second electrode 302 and the electron transporting layer 314, any of various conductive materials such as Al, Ag, ITO, or indium tin oxide containing silicon or silicon oxide can be used for the second electrode 302 regardless of the magnitude of the work function. Note that, although not shown in this embodiment mode, a sealing layer which can suppress permeation of water and oxygen may be formed over the second electrode 302. For this layer, an inorganic oxide, an inorganic nitride, or the like can be used.

In the light-emitting element having the above structure, which is described in this embodiment mode, a current flows by application of a voltage between the first electrode 301 and the second electrode 302. Then, holes and electrons are recombined in the light-emitting layer 313, whereby light is emitted. Note that an electrode through which light is extracted may be selected optionally. That is, light may be extracted to outside through one or both of the first electrode 301 and the second electrode 302, and an electrode having a light transmitting property may be used for an electrode through which light is extracted.

FIG. 6A shows the structure where the first electrode 301 which functions as an anode is provided on the substrate 300 side, but the second electrode 302 which functions as a cathode may be provided on the substrate 300 side. For example, as shown in FIG. 63, a structure may be employed, in which the second electrode 302 which functions as a cathode, the EL layer 303, and the first electrode 301 which functions as an anode are stacked over the substrate 300 in this order that is opposite to the order in the structure shown in FIG. 6A.

The EL layer and the electrodes can be formed by any of various methods regardless of whether it is a dry method or a wet method. The electrodes and the layers may each be formed using a different method. Examples of a dry method include a vacuum evaporation method, a sputtering method, and the like. Examples of a wet method include an inkjet method, a spin coating method, a sol-gel method, and the like. For example, the EL layer may be formed by a wet method using a high molecular compound among the above-mentioned materials. Alternatively, the EL layer may be formed by a wet method using a low molecular organic compound. Still alternatively, the EL layer may be formed by a dry method such as a vacuum evaporation method using a low molecular organic compound.

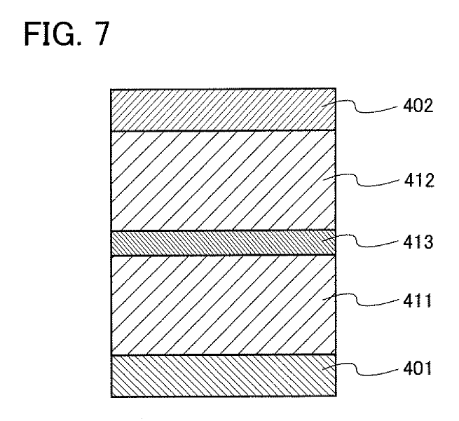

Note that a light-emitting element having a structure in which a plurality of light-emitting units is stacked (hereinafter referred to as a stacked element) may be employed. This stacked element is that in which a first light-emitting unit 411 and a second light-emitting unit 412 are stacked between a first electrode 401 and a second electrode 402 as shown in FIG. 7. The first electrode 401 and the second electrode 402, and the first light-emitting unit 411 and the second light-emitting unit 412 can be formed using the above-mentioned material and formation method. Furthermore, the first light-emitting unit 411 and the second light-emitting unit 412 may have the same structure or different structures and may emit different colors of light.

A charge generating layer 413 contains a composite material of an organic compound and a metal oxide. This composite material of an organic compound and a metal oxide is the composite material described above and contains an organic compound and a metal oxide such as vanadium oxide, molybdenum oxide, or tungsten oxide. Alternatively, the charge generating layer 413 may be formed using a transparent conductive film or a metal oxide film.

Note that the charge generating layer 413 may be formed using a combination of a composite material of an organic compound and a metal oxide with another material. For example, the charge generating layer 413 may be formed using a combination of a layer which contains a composite material of an organic compound and a metal oxide with a layer which contains an electron donating material and an electron transporting material. Alternatively, the charge generating layer 413 may be formed using a combination of a layer which contains a composite material of an organic compound and a metal oxide with a transparent conductive film.

Note that, although the light-emitting element having two light-emitting units is described above, a light-emitting element in which three or more light-emitting units are stacked in a similar manner can be similarly employed.

Note that this embodiment mode can be appropriately combined with any of the other embodiment modes.

### Embodiment Mode 4

In this embodiment mode, electronic devices which each include in its part the light-emitting device described in any of Embodiment Modes 1 to 3 are described.

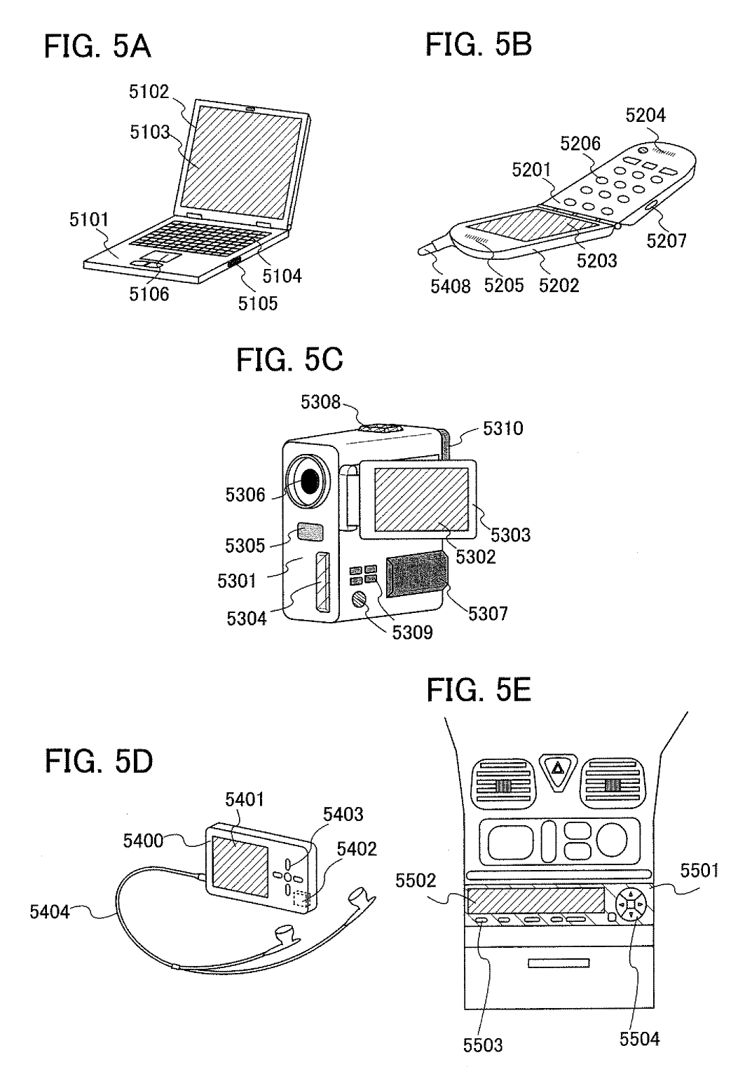

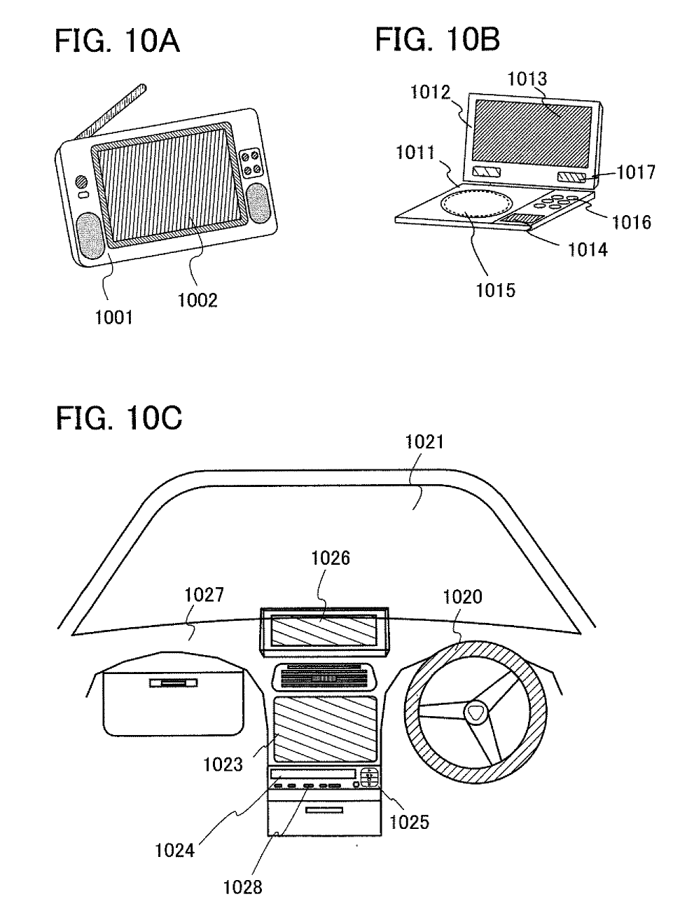

Examples of electronic devices manufactured using the light-emitting device of the present invention include: a camera such as a video camera or a digital camera, a goggle-type display, a navigation system, a sound reproducing device (a car audio system, an audio component, or the like), a computer, a game machine, a portable information terminal (a mobile computer, a cellular phone, a mobile game machine, an electronic book reader, or the like), an image reproducing device provided with a recording medium (specifically, a device for reproducing a recording medium such as a digital versatile disc (DVD) and having a display device for displaying the image), and the like. Specific examples of these electronic devices are shown in FIGS. 5A to 5E and FIGS. 10A to 10c.

FIG. 5A shows a computer of this embodiment mode, which includes a main body 5101, a chassis 5102, a display portion 5103, a keyboard 5104, an external connection port 5105, a pointing device 5106, and the like. In this computer, the display portion 5103 includes a light-emitting device which is similar to those described in Embodiment Modes 1 to 3. An environment where such an electronic device as shown in the diagram is that in which a user can stay comfortably to some extent, and such an electronic device is not usually used in an environment which is harsh to a user, for example, in an environment where the temperature is 40° C. or higher. At such an ambient temperature, a light-emitting device does not need to be operated; therefore, the light-emitting device of the present invention can be effectively used. In addition, it is contemplated that there is the case where a user forgets to turn off an electronic device and its external environment is changed with the light-emitting device kept in an on state, whereby the electronic device is exposed to high temperature. However, by use of the light-emitting device of the present invention, the light-emitting device can be stopped in an external environment at a high temperature, and light emission can be prevented in a condition that a user does not desire. As a result, the lifetime of the light-emitting device can be extended.

FIG. 5B shows a cellular phone of this embodiment mode, which includes a main body 5201, a chassis 5202, a display portion 5203, an audio input portion 5204, an audio output portion 5205, operation keys 5206, an external connection port 5207, an antenna 5208, and the like. In this cellular phone, the display portion 5203 includes a light-emitting device which is similar to those described in Embodiment Modes 1 to 3. Similar to such a portable computer as shown in FIG. 5A, an environment where an electronic device such as a cellular phone is used is that in which a user can stay comfortably to some extent, and an electronic device is not usually used or is rarely used in an environment which is harsh to a user, for example, in an environment where the temperature is 40° C. or higher At such an ambient temperature, a light-emitting device does not need to be operated; therefore, the light-emitting device of the present invention can be effectively used. In addition, it is contemplated that there is the case where a user leaves the electronic device in an environment, such as in an automobile, where the electronic device may be exposed to high temperature. Then, when the electronic receives a call signal while being exposed to a harsh ambient environment at a high temperature, there is a possibility that the light-emitting device is turned on at a high temperature. When a light-emitting element is driven in such a harsh environment, the lifetime of the light-emitting element is significantly shortened, which results in a significant reduction in lifetime of a display portion having the light-emitting device of the present invention. However, by use of the light-emitting device of the present invention, the light-emitting device can be stopped in an external environment at a high temperature, and light emission can be prevented in a condition that a user does not desire. As a result, the lifetime of the light-emitting device can be extended.

FIG. 5C shows a portable video camera of this embodiment mode. The portable video camera shown in FIG. 5C includes, in a main body 5301, a display portion 5302, a chassis 5303, an external connection port 5304, a remote control receiving portion 5305, an image receiving portion 5306, a battery 5307, an audio input portion 5308, operation keys 5309, and an eye piece portion 5310. The display portion 5302 can include any of the light-emitting devices of Embodiment Modes 1 to 3. By use of the light-emitting device of the present invention, light emission of the light-emitting device can be stopped in a harsh external environment where a user does not usually use an electronic device, specifically, at a high temperature where a user cannot stay comfortably. Therefore, for example, in the case where the light-emitting device is kept in an on state because a user forgets to turn off an electronic device and an external environment becomes harsh, light emission of the display portion can be automatically stopped. As a result, the lifetime of the electronic device can be extended.

FIG. 5D shows a digital player of this embodiment mode. The digital player shown in FIG. 5D includes a main body 5400, a display portion 5401, a memory portion 5402, an operation portion 5403, earphones 5404, and the like. Note that, instead of the earphones 5404, headphones or wireless earphones can be used. The display portion 5401 can include any of the light-emitting devices described in Embodiment Modes 1 to 3. By use of the light-emitting device of the present invention, light emission of the light-emitting device can be stopped in a harsh external environment where a user does not usually use an electronic device, specifically, at a high temperature where a user cannot stay comfortably. Therefore, for example, in the case where the light-emitting device is kept in an on state because a user forgets to turn off an electronic device and an external environment becomes harsh, light emission of the display portion can be automatically stopped. As a result, the lifetime of the electronic device can be extended.

FIG. 5E shows a sound reproducing device, specifically, a car audio system, which includes a main body 5501, a display portion 5502, and operating switches 5503 and 5504. In the display portion 5502, any of the light-emitting elements and the light-emitting devices described in Embodiment Modes 1 to 3 are incorporated. The light-emitting device of the present invention is suitable for such an in-vehicle display. For example, when an automobile is left exposed to direct sunlight in summer, the temperature inside the automobile becomes very high. If an engine is started in such a situation, and at the same time, the car audio system is driven and the light-emitting device is turned on, the lifetime of the light-emitting element included in the light-emitting device is significantly shortened. However, in such a case, the automobile is usually used after an in-vehicle air conditioner is driven and an environment in which a user can stay comfortably to some extent is created. Therefore, before an environment in which the temperature inside the automobile is comfortable to a user to some extent is created, there is little need to turn on the light-emitting device. Therefore, by use of an in-vehicle electronic device in which the light-emitting device of the present invention is incorporated, the light-emitting device can be stopped in an external environment at a high temperature, and light emission can be prevented in a condition that a user does not desire. As a result, the lifetime of the electronic device can be extended.

FIG. 10A shows a portable television device, which includes a main body 1001, a display portion 1002, and the like. In the display portion 1002, any of the light-emitting elements and the light-emitting devices described in Embodiment Modes 1 to 3 are incorporated. By use of the light-emitting device of the present invention, light emission of the light-emitting device can be stopped in a harsh external environment where a user does not usually use an electronic device, specifically, at a high temperature where a user cannot stay comfortably. Therefore, for example, in the case where the light-emitting device is kept in an on state because a user forgets to turn off an electronic device and an external environment becomes harsh, light emission of the display portion 1002 can be stopped. Alternatively, in the case where the display portion is unintentionally turned on by a mistake in operation in a condition where an external environment is harsh, the lifetime of the light-emitting device included in the display portion is significantly shortened. However, by application of the present invention, the lifetime of the electronic device can be extended.

FIG. 10B shows an image reproducing device provided with a recording medium (specifically, a DVD player), which includes a main body 1011, a chassis 1012, a display portion A 1013, a display portion B 1014, a recording medium (DVD or the like) reading portion 1015, operation keys 1016, a speaker portion 1017, and the like. The display portion A 1013 mainly displays image information and the display portion B 1014 mainly displays text information. The present invention is applied to a light-emitting device included in each of the display portion A 1013 and the display portion B 1014. By use of the light-emitting device of the present invention, light emission of the light-emitting device can be stopped in a harsh external environment where a user does not usually use an electronic device, specifically, at a high temperature where a user cannot stay comfortably. Therefore, for example, in the case where the light-emitting device is kept in an on state because a user forgets to turn off an electronic device and an external environment becomes harsh, light emission of each of the display portion A 1013 and the display portion B 1014 can be stopped. Alternatively, in the case where the display portion is unintentionally turned on by a mistake in operation in a condition where an external environment is harsh, the lifetime of the light-emitting device included in the display portion is significantly shortened. However, by application of the present invention, the lifetime of the electronic device can be extended.

FIG. 10C shows an example in which an electronic device manufactured using the light-emitting device of the present invention is incorporated in an automobile. Here, an automobile is given as a typical example of vehicles, but the present invention is not limited thereto and can also be applied to an aircraft, a train, and the like. FIG. 10C is a diagram showing an area near a driver's seat of an automobile. A dashboard 1027 is provided with a sound reproducing device, specifically an audio system, and a navigation system. A main body 1025 of the audio system includes a display portion 1024 and operation buttons 1028. On the other hand, the navigation system includes a display portion 1023. In this example, a display portion 1026 for displaying necessary information for driving, for example, the condition of air conditioning inside the automobile is also shown. Note that, although the in-vehicle audio system and navigation system are described in this embodiment mode, the light-emitting device of the present invention may be used for an indicator of another vehicle or for a stationary audio system or navigation system. The light-emitting device of the present invention is suitable for light-emitting devices included in the display portions 1023, 1024, and 1026 of these in-vehicle electronic devices, and the like. For example, when an automobile is left exposed to direct sunlight in summer, the temperature inside the automobile becomes very high. If an engine is started in such a situation, and at the same time, any of these display portions is driven and the light-emitting device is turned on, the lifetime of the light-emitting element included in the light-emitting device is significantly shortened. However, in such a case, the automobile is usually used after an in-vehicle air conditioner is driven and an environment in which a user can stay comfortably to some extent is created. Therefore, before an environment where the temperature inside the automobile is comfortable to a user to some extent is created, there is little need to turn on the light-emitting device. Therefore, by use of an in-vehicle electronic device in which the light-emitting device of the present invention is incorporated, the light-emitting device can be stopped in an external environment at a high temperature, and light emission can be prevented in a condition that a user does not desire As a result, the lifetime of the electronic device can be extended.

As described above, the applicable range of the light-emitting device manufactured according to the present invention is so wide that the light-emitting device can be applied to any field of electronic devices. Note that this embodiment mode can be appropriately combined with any of the other embodiment modes.

This application is based on Japanese Patent Application serial no. 2007-178727 filed with Japan Patent Office on Jul. 6, 2007, the entire contents of which are hereby incorporated by reference.

What is claimed is:

1. A light-emitting device comprising:
a pixel portion having a light-emitting element;
a control switch electrically connected to the pixel portion; and
a sensor portion electrically connected to the control switch,
wherein the control switch includes a unit configured to determine whether the light-emitting element emits light depending on an ambient temperature that is sensed by the sensor portion.

2. The light-emitting device according to claim 1, wherein the pixel portion, the control switch and the sensor portion are provided over a single insulator.

3. The light-emitting device according to claim 1, wherein the light-emitting element is an organic electroluminescence element.

4. The light-emitting device according to claim 1, wherein the light-emitting element is electrically connected to a thin film transistor.

5. The light-emitting device according to claim 1, wherein the light-emitting element is provided between a first electrode formed in a stripe shape and a second electrode formed in a stripe shape perpendicular to the first electrode.

6. An electronic device comprising the light-emitting device according to claim 1.

7. A light-emitting device comprising:
a pixel portion having a light-emitting element;
a driver circuit electrically connected to the pixel portion;
a control switch electrically connected to the driver circuit; and
a sensor portion electrically connected to the control switch,
wherein the control switch includes a unit configured to determine whether the light-emitting element emits light depending on an ambient temperature that is sensed by the sensor portion.

8. The light-emitting device according to claim 7, wherein the pixel portion, the control switch and the sensor portion are provided over a single insulator.

9. The light-emitting device according to claim 7, wherein the light-emitting element is an organic electroluminescence element.

10. The light-emitting device according to claim 7, wherein the light-emitting element is electrically connected to a thin film transistor.

11. The light-emitting device according to claim 7, wherein the light-emitting element is provided between a first electrode formed in a stripe shape and a second electrode formed in a stripe shape perpendicular to the first electrode.

12. An electronic device comprising the light-emitting device according to claim 7.

13. A driving method of a light-emitting device including a pixel portion having a light-emitting element, a control switch electrically connected to the pixel portion, and a sensor portion electrically connected to the control switch, comprising the steps of:
emitting the light-emitting element of the pixel portion;
detecting an ambient temperature around the light-emitting device; and
turning off the light-emitting element by the control switch when the ambient temperature is equal to or higher than a predetermined temperature.

14. A driving method of a light-emitting device including a pixel portion having a light-emitting element, a driver circuit electrically connected to the pixel portion, a control switch electrically connected to the driver circuit, and a sensor portion electrically connected to the control switch, comprising the steps of:
emitting the light-emitting element of the pixel portion;
detecting an ambient temperature around the light-emitting device; and
turning off the light-emitting element by the control switch and the driver circuit when the ambient temperature is equal to or higher than a predetermined temperature.
